(19) United States
(12) Patent Application Publication
(10) Pub. No.: US 2010/0176228 A1
(43) Pub. Date: Jul. 15, 2010

(54) Safety switch of a shredder

(75) Inventor: Yung-Hao Huang, SanChung City (TW)

Correspondence Address: BACON & THOMAS, PLLC, 625 SLATERS LANE, FOURTH FLOOR, ALEXANDRIA, VA, 22314-1176, US

(73) Assignee: Michilin Prosperity Co., Ltd., SanChung City (TW)

(21) Appl. No.: 12/318,983

(22) Filed: Jan. 14, 2009

(51) Int. Cl. B02C 23/04

(52) U.S. Cl. 241/36

(57) ABSTRACT

This specification discloses an improved safety switch of a shredder. The paper outlet at the bottom of the shredder housing is provided with several switches around it, each of which is connected by a wire with another one in series to form a switch circuit. The switch circuit is connected through wires with a shredder control circuit to form s closed circuit. The switch is triggered by an external force, and the signal is transferred to the next switch. If the next switch is not triggered by an external force, the signal is interrupted and stopped. In other words, the switch circuit cannot form a closed circuit with the shredder control circuit and the shredder cannot function.

### BACKGROUND OF THE INVENTION

1. Field of Invention

The invention relates to a shredder and, in particular, to an improved safety switch of a shredder.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

A usual shredder includes a housing, a paper inlet for the insertion of paper, and a shredder mechanism disposed inside the housing for shredding paper. The shredder mechanism includes cutting blades mounted on rotary shafts. A motor and a gearbox drive the two parallel rotary shafts rotating in opposite directions to cut passing paper sheets into chips. A basket or bin is disposed under the paper outlet at the bottom of the housing holding paper chips.

When the basket is full and the chips have to be removed, one normally lifts the shredder from the opening of the basket, separating the two. Afterwards, the chips in the basket are put into a plastic bag, which is then thrown, away or recycled. For the safety reason, the bottom of the shredder housing is usually disposed with a touch-control safety switch. The corresponding position on the basket is a pressing bar. When the shredder is disposed on the opening of the basket, the safety switch is urged by the pressing bar. The control circuit of the shredder is then turned on for shredding paper. On the other hand, when the shredder is removed from the opening of the basket, the safety switch and the pressing bar depart from each other. The control circuit of the shredder is turned off for the safety of the operator.

However, if the user uses a tool such as a screwdriver to press the safety switch when the shredder is moved away from the opening of the basket, the control circuit of the shredder is still turned on. Therefore, there is still a potential risk for the user to careless touch the safety switch. It is necessary to improve the structure for the safety reason.

### SUMMARY OF THE INVENTION

In view of the foregoing, an objective of the invention is to provide an improved safety switch of a shredder. In the disclosed device, the paper outlet at the bottom of the shredder housing is surrounded by a plurality of switches, each of which is electrically connected by a wire with another switch to form a switch circuit. The switch circuit is then connected via wires with the shredder control circuit to form a closed circuit. The switch is triggered by an external force, and the signal is transferred to the next switch. If the next switch is not triggered by an external force, the signal is interrupted and stopped. In other words, the switch circuit cannot form a closed circuit with the shredder control circuit and the shredder cannot function.

### BRIEF DESCRIPTION OF THE DRAWINGS

The invention will become more fully understood from the detailed description given herein below illustration only, and thus is not limitative of the present invention, and wherein:

FIG. 1 shows the configuration of an improved safety switch of a shredder according to the invention.

### DETAILED DESCRIPTION OF THE INVENTION

The present invention will be apparent from the following detailed description, which proceeds with reference to the accompanying drawings, wherein the same references relate to the same elements.

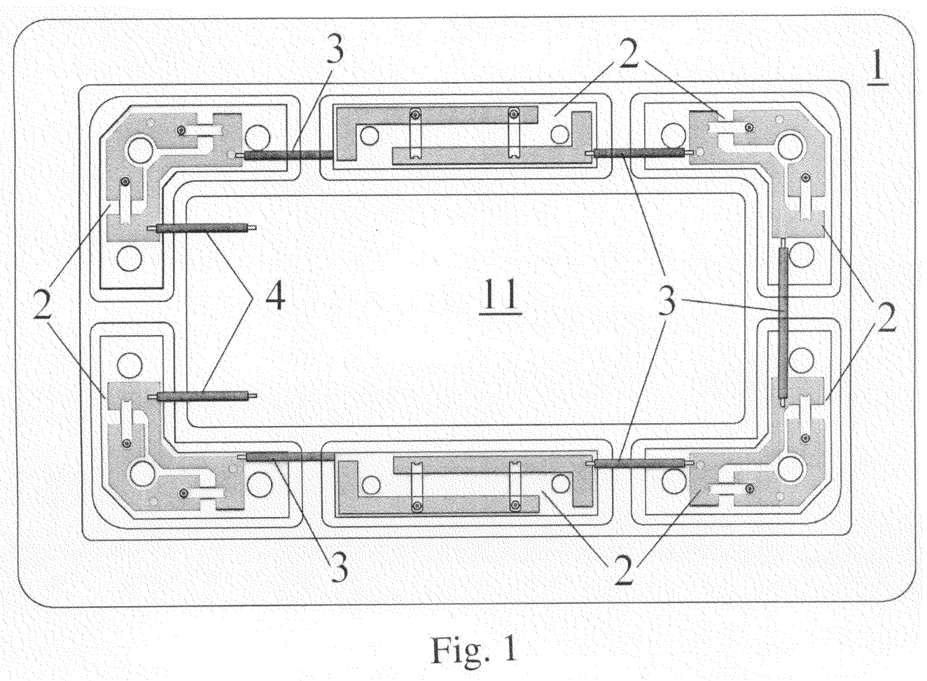

Please refer to FIG. 1 for the configuration of the improved safety switch of a shredder according to the invention. As shown in the drawing, the open paper outlet 11 at the bottom of the shredder housing 1 is surrounded by several switches 2. Each of the switches 2 is connected in series by a wire with another switch 2 to form a switch circuit. The switch circuit is then connected by wires 4 with the shredder control circuit (not shown) to form a closed circuit.

In particular, the switch can be designed as a circuit board. An external force is required to turn on the circuit board and to transmit the signal to the next circuit board. Suppose the next circuit board is not triggered by an external force, the power transmission is interrupted and stopped. In other words, the switch circuit cannot form a closed circuit with the shredder control circuit and the shredder cannot function.

According to the above description, the switch circuit cannot form a closed circuit if any of the switches is not turned on. As a result, the shredder cannot be turned on to shredder paper. On the other hand, when all of the switches are triggered and turned on, the switch circuit and the shredder control circuit form a closed circuit. In this case, the shredder is turned on. In comparison with the traditional design with a single safety switch, the series circuit of multiple switches in this invention provides more safety.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An improved safety switch of a shredder comprising a plurality of switches disposed around the paper outlet at the bottom of the shredder housing, wherein any of the switches is electrically connected with another switch to form a switch circuit, and the circuit switch is connected with the shredder control circuit to form a closed circuit.

2. The improved safety switch of a shredder as in claim 1, wherein each of the switches is a circuit board that is triggered by an external force to turn on.
